(19) United States
(12) Patent Application Publication
(10) Pub. No.: US 2015/0023204 A1
(43) Pub. Date: Jan. 22, 2015

(54) SYSTEMS AND METHODS FOR COMBINED WIRELESS POWER CHARGING AND NETWORK PAIRING

(71) Applicant: General Electric Company, Schenectady, NY (US)

(72) Inventors: Steven William Wik, Niskayuna, NY (US); David Michael Davenport, Niskayuna, NY (US); SM Shajedul Hasan, Niskayuna, NY (US)

(73) Assignee: General Electric Company, Schenectady, NY (US)

(21) Appl. No.: 13/946,482

(22) Filed: Jul. 19, 2013

(51) Int. Cl. H04W 48/14; H04W 4/00; H04W 72/04

(52) U.S. Cl. CPC H04W 48/14; H04W 72/0453; H04W 4/008
USPC 370/254

(57) ABSTRACT

A system includes a first network member that includes a first channel and a second channel. The first channel is configured as a charging channel and is configured to at least one of wirelessly receive or transmit power. The first channel is also configured to transmit network pairing information for at least one of pairing or un-pairing the first network member and a second network member. The network pairing information is transmitted over the first channel at a first frequency. The second channel is configured as an operational channel, and is configured to communicate operational information between the first and second network members when the first and second network members are paired. The operational information is transmitted over the second channel at a second frequency that is different than the first frequency.

### BACKGROUND

Networks may include one or more nodes, such as devices configured to provide information to other aspects or elements of a network. Networks may use a gateway or network administrator to manage the nodes of a network, including the addition or joining of nodes to the network and/or the removal or un-joining of nodes from the network. Generally, provisions may be made to attempt to ensure that only legitimate members or prospective members of the network are allowed to join. As part of a pairing process joining a node to a network, authentication information (such as identification information, a password or other key, or the like) may be exchanged or shared between the node and a network administrator or gateway.

Conventional systems suffer from a number of drawbacks in the joining of nodes to a network and/or the removal of nodes from a network. For example, in some conventional networks, communications for pairing a node to a network may cause interference with the collection of data from one or more other nodes (e.g., nodes attempting to transmit data or network administrators attempting to receive data). As another example, in some conventional networks, an operator or other personnel may be required to manually enter a password, identifier, or other information. Such manually entered information, however, is subject to human error, for example in entry of the password, identifier, or other information. Further, such manual entry of information may cause issues with sterilization in medical environments. In some conventional networks, hardware or componentry associated with the joining and un-joining of nodes to and from a network administrator or gateway may require additional equipment, resulting in increased cost, size, and/or maintenance requirements. Further still, the process of joining and un-joining nodes to and from a network administrator or gateway may be subject to malicious activity such as malicious interception of messages transmitted between nodes and gateways.

### BRIEF DESCRIPTION

In one embodiment, a system is provided including a first network member that includes a first channel and a second channel. The first channel is configured as a charging channel and is configured to at least one of wirelessly receive or transmit power. The first channel is also configured to transmit network pairing information for at least one of pairing or un-pairing the first network member and a second network member. The network pairing information is transmitted over the first channel at a first frequency. The second channel is configured as an operational channel, and is configured to communicate operational information between the first and second network members when the first and second network members are paired. The operational information is transmitted over the second channel at a second frequency that is different than the first frequency. For example, in some embodiments the operational information may be transmitted at a second frequency that is higher than the first frequency, while in some embodiments, the operational information may be transmitted at a second frequency that is lower than the first frequency.

In another embodiment, a tangible and non-transitory computer readable medium is provided that includes one or more computer software modules configured to direct one or more processors to identify, at a module of a network coordinator, a node for one of pairing or un-pairing to the network coordinator. The one or more computer software modules are also configured to direct the one or more processors to communicate network pairing information with the node via a first channel. The network pairing information is configured to at least one of pair or un-pair the network coordinator and the node. The first channel is configured to wirelessly transmit power from the network coordinator to the node. The network pairing information is transmitted over the first channel at a first frequency. Also, the one or more computer software modules are configured to direct the one or more processors to communicate operational information with the node via a second channel when the network coordinator and the node are paired. The operational information is transmitted over the second channel at a second frequency that is different than the first frequency. For example, in some embodiments the operational information may be transmitted at a second frequency that is higher than the first frequency, while in some embodiments, the operational information may be transmitted at a second frequency that is lower than the first frequency.

In another embodiment, a tangible and non-transitory computer readable medium is provided that includes one or more computer software modules configured to direct one or more processors to identify, at a module of a node, a network coordinator for one of pairing or un-pairing to the node. The one or more computer software modules are also configured to direct the one or more processors to communicate network pairing information with the network coordinator via a first channel. The network pairing information is configured to at least one of pair or un-pair the node and the network coordinator. The first channel is configured to wirelessly receive power from the network coordinator. The network pairing information is transmitted over the first channel at a first frequency. Further, the one or more computer software modules are also configured to direct the one or more processors to communicate operational information with the network coordinator via a second channel when the node and the network coordinator are paired. The operational information is transmitted over the second channel at a second frequency that is different than the first frequency. For example, in some embodiments the operational information may be transmitted at a second frequency that is higher than the first frequency, while in some embodiments, the operational information may be transmitted at a second frequency that is lower than the first frequency.

### BRIEF DESCRIPTION OF THE DRAWINGS

FIG. 1 is a schematic block diagram of a network in accordance with various embodiments.

FIG. 2 is a flow diagram depicting the pairing of and communication between a coordinator and a node in accordance with various embodiments.

FIG. 3 is a schematic view of a network including a monitor and sensing devices in accordance with various embodiments.

FIG. 4 is a flowchart of a method for operating a node in accordance with various embodiments.

FIG. 5 is a flowchart of a method for operating a network coordinator in accordance with various embodiments.

### DETAILED DESCRIPTION

Various embodiments will be better understood when read in conjunction with the appended drawings. To the extent that the figures illustrate diagrams of the functional blocks of various embodiments, the functional blocks are not necessarily indicative of the division between hardware circuitry. Thus, for example, one or more of the functional blocks (e.g., processors, controllers or memories) may be implemented in a single piece of hardware (e.g., a general purpose signal processor or random access memory, hard disk, or the like) or multiple pieces of hardware. Similarly, any programs may be stand-alone programs, may be incorporated as subroutines in an operating system, may be functions in an installed software package, and the like. It should be understood that the various embodiments are not limited to the arrangements and instrumentality shown in the drawings.

As used herein, the terms “system,” “unit,” or “module” may include a hardware and/or software system that operates to perform one or more functions. For example, a module, unit, or system may include a computer processor, controller, or other logic-based device that performs operations based on instructions stored on a tangible and non-transitory computer readable storage medium, such as a computer memory. Alternatively, a module, unit, or system may include a hard-wired device that performs operations based on hard-wired logic of the device. The modules or units shown in the attached figures may represent the hardware that operates based on software or hardwired instructions, the software that directs hardware to perform the operations, or a combination thereof. As used herein, an element or step recited in the singular and proceeded with the word “a” or “an” should be understood as not excluding plural of said elements or steps, unless such exclusion is explicitly stated. Furthermore, references to “one embodiment” are not intended to be interpreted as excluding the existence of additional embodiments that also incorporate the recited features. Moreover, unless explicitly stated to the contrary, embodiments “comprising” or “having” an element or a plurality of elements having a particular property may include additional such elements not having that property.

Generally, various embodiments provide for the use of wireless charging circuits (e.g., inductive charging circuits) to provide low data rate communication to assist in the association and disassociation of one or more wireless nodes to high data rate wireless network. The network may be controlled, for example, by a central gateway device, such as a network coordinator or gateway. In various embodiments, by way of example, high data rate communications may be based on one or more of Time-Division Multiple access (TDMA), Frequency Division Multiple Access (FDMA), or Code Division Multiple Access (CDMA), among others. In various embodiments, the low data rate communication may only occur when wireless, charging circuitry of a node and a network coordinator are positioned closely enough to support wireless charging. Further, the low data rate communication of the wireless charging circuit may be used to provide location information and/or to trigger a location or environment-specific network configuration. As one example, a node may be instructed to “turn off.” As another example, a node may be instructed to use a specific set of frequency bands for high data rate communication for a particular network administrator or environment. The charging functionality of the circuitry may be retained and the node may be able to charge one or more power sources or storage devices wirelessly on a frequency band that is separate from the high data rate network during and after network association and disassociation.

For example, in various embodiments, a disassociated node (e.g., a node that is not yet a member of a network, joined to a network, or paired to an administrator or gateway of a network) may be brought within a wireless charging proximity of a network coordinator. With the node and administrator in charging proximity, wireless charging circuits or channels of the node and administrator may then exchange device specific identification information (e.g., via the use of radiofrequency (RF) backscatter) to allow the node (and/or the network administrator) to perform authentication and for the node to become associated with the network administrator. With the node associated, the node and network administrator may exchange or communicate information using high data rate channels or circuits to communicate via the high data rate network.

Further, in various embodiments, when a node that is already associated is brought within wireless charging proximity of the network coordinator to which the node is associated, the wireless charging circuits of the node and network administrator may exchange device specific identification information thereby allowing the network coordinator (and/or the node) to perform authentication and to disassociate the node, removing the node from the high data rate network.

As one example, in various embodiments utilizing a TDMA-based wireless protocol, an authentication procedure may be performed by obtaining or freeing up the time slot of the node in the TDMA frame. The 2-way low data rate communication between the two devices in close proximity helps ensure that a node is associated or disassociated from only the TDMA frame with which the node is attempting to obtain a slot or disassociate from. Put another way, an associated node will not disassociate from the network coordinator of the node unless the node is brought with wireless charging proximity of that particular network coordinator. Conversely, a node will only associate to the network coordinator with which the node is in wireless charging proximity.

Thus, in various embodiments, a low data rate communication link that may have a first functionality of managing inductive charging of a node (e.g., a battery of a node) may also be utilized to trigger and/or perform the adding and removing (or associating or disassociating) of the node to a network that utilizes a higher bandwidth communication for regular, standard, or operational information. As used herein, operational information may be understood as information exchanged between a node and a network administrator as part of the intended operation of the node, network, and/or system including the network or node, in contrast to information sent for the purpose of adding nodes to the network or removing nodes from the network. For example, in a network including a monitor configured as a network administrator and nodes configured as sensing devices, the intended operation of the network may include the collection of data by the sensing devices, and the transmission of information corresponding to the collected data to the monitor (e.g., for processing and/or display). Thus, operational information of such a network includes the information that is transmitted from the sensing devices to the monitor corresponding to the collected data of the sensing devices, as well as control information transmitted by the monitor to the sensing devices for use in acquiring data. In contrast, information (e.g., identification or authentication information) sent for the purpose of pairing or un-pairing a node and network administrator is not considered operational information as used herein.

It should be noted that, while the network coordinator may communicate with the node and provide energy to the node via the wireless charging channel or circuitry, the network coordinator may not necessarily be the source of the battery charging energy for the node in various embodiments. For example, one or more stand-alone battery charger devices may be employed to charge (e.g., inductively charge) the battery of the node. Thus, in some embodiments, the network coordinator may have charging capability which would allow the network coordinator to start a battery charging event for the purpose of confirming the presence of a node and exchanging identifying or other information for network pairing with the node, while the node may receive additional battery charging from a separate charging device.

Thus, various embodiments provide for the addition of a node to or the removal of a node from a network without causing interference to operation of the network or impacting current data collection. For example, communications for adding a node (or removing a node) may be performed using a first, low rate data communication path while operation of the network (e.g., data collection) may be performed using a second, high rate data communication path. Thus, in some embodiments, the first data communication path (utilized for pairing or un-pairing) may employ a frequency that is lower than the second data communication path (utilized to communicate operational information). In various alternate embodiments, the first data communication path may employ a frequency that is higher than the second data communication path. Further, a network coordinator can set or schedule the time of association or disassociation with a node at convenient time. Various embodiments also provide for the addition or removal of a node to a network in a reliable manner that reduces human involvement and helps ensure that the intended pairing is made. For example, instead of using manually entered passwords or other entries, a node and network may be paired by placement of the node within a predetermined range of a network administrator. Additionally, various embodiments provide for addition and removal of a node to a network with improved security. For example, unique identifier information may be shared over a relative short transmission distance (e.g., about 2 inches or about 5 centimeters) which may be very difficult for a malicious attempt by a third party to intercept or interfere with. Further still, various embodiments provide for savings in terms of space, weight, cost of materials, or cost to build, among others, for example by utilizing a shared antenna and/or other componentry for both low rate data communications and wireless charging. Further still, in various embodiments, the risk of a false network association and/or data collision due to wireless interference is reduced, minimized, or eliminated. Yet further still, in various embodiments, a system of network management and location services may be provided having the ability to detect and/or track the location of a particular location of a node based on wireless charging circuitry with which the node comes into contact, such as a charging pad or station, or, as another example, a network administrator.

In various embodiments, the use of a low data rate, battery charging management wireless communication link (e.g., via backscatter) may be understood as an “out of band” signaling channel, in that the channel is “out of band” with respect to a higher data rate radio frequency link used for regular or intended operation communication within the network. The out of band, low data rate link may provide a convenient “trigger” mechanism. It may be noted that, in various alternate embodiments, the “out of band” signaling channel may be configured for a higher frequency than the “in band” radio frequency link used for regular or intended operation communication within the network. Both a node and a coordinator may be triggered by a proximity and alignment of inductive charging coils, for example. Such a trigger may be used to exchange a unique identification and/or subset of frequency channels on which to perform network management tasks. The trigger may also force the coordinator to start network management tasks at a time that is convenient, for example during time slots unused by other sensors on the network. In some embodiments, the trigger may also force the node to wait in a receive state for messages from coordinator over the higher data rate communication link.

At least one technical effect of various embodiments is reduced cost and/or complexity of network elements. For example, in various embodiments, board space on a printed electronics board may be conserved. At least one technical effect of various embodiments is improved security for pairing and un-pairing from a network. At least one technical effect of various embodiments is the reduction of error, such as human error, in the pairing and un-pairing of nodes from a network. At least one technical effect of various embodiments is increased reliability in pairing and un-pairing nodes from a network. At least one technical effect of various embodiments is improved sterilization in medical applications. At least one technical effect of various embodiments is improved location determination and improved utilization of location-based content and/or location-based control

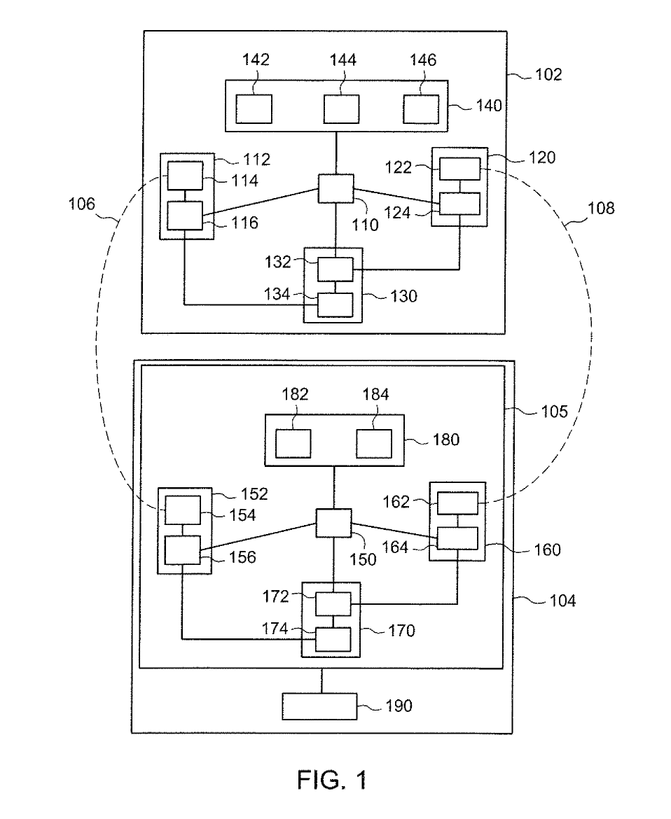

FIG. 1 is a schematic block diagram of a network 100 in accordance with various embodiments. As shown in FIG. 1, the network 100 includes a node 102 and a network administrator 104. The node 102 and the network administrator 104 are communicably coupled via two pathways, namely, a first pathway 106 and a second pathway 108. The node 102 and the network administrator 104 may be configured, for example, for wireless communication between each other via two distinct routes provided by the first pathway 106 and the second pathway 108. For example, the pathways 106, 108 may be configured for wireless communication at different frequencies (or frequency ranges). The network 100 of FIG. 1 depicts only one node 102 and one network administrator 104 for simplicity and ease of illustration; however, additional nodes and/or network administrators may be employed in various embodiments. For example, in various embodiments, plural nodes may be concurrently connectable to or detachable from a network coordinator.

Additionally or alternatively, one or more nodes may be transferable from a first network coordinator to one of plural additional network coordinators. For example, a node may be initially associated with a first network coordinator, later un-paired or disassociated from the first network coordinator, and subsequently associated or paired with a second network coordinator. In various embodiments, the network 100 may be configured with one or more nodes configured as sensors or data collection devices configured to provide information to a network administrator (or administrators) configured as a monitor for processing, analyzing, and/or displaying the information provided by the nodes. As just one example, the network 100 may be configured for use in a health care or hospital setting. For example, nodes may be configured as sensors (e.g., sensors configured to be attached to, worn by, or otherwise mounted in proximity to a patient) for collecting physiological information regarding the patient, and the network administrators may be configured as monitors for receiving the information from the sensors (nodes), analyzing or otherwise processing the information, and providing a display corresponding to the information. Each monitor may be configured to receive information from sensors detecting information from a particular patient. Thus, a particular sensor or node may be un-paired from a first monitor associated with a first patient, moved to a different room or area for use with a second patient, paired with a second monitor associated with the second patient, and then attached or otherwise associated with the second patient to provide information to the second monitor. In various embodiments, wireless communication between a network administrator and nodes may be performed pursuant to one or more standard wireless protocols, such as wi-fi, Bluetooth, or the like.

As indicated above, the node 102 and the network administrator 104 may be configured, for example, for wireless communication between each other via two distinct routes provided by the first pathway 106 and the second pathway 108. In various embodiments, the node 102 and the network administrator 104 may include respective first low frequency antennae for communication via the first pathway 106 and respective second high frequency antennae for communication via the second pathway 108.

In the embodiment depicted in FIG. 1, the first pathway 106 is configured as a wireless charging and low frequency communication pathway, while the second pathway 108 is configured as a high frequency communication pathway. In the illustrated embodiment, the first pathway 106 is configured for the wireless transfer of energy between the network administrator 104 and the node 102, as well as for the exchange of network pairing information between the node 102 and the network administrator 104. The wireless transfer of energy from the network administrator 104 may be utilized in some embodiments for power to be used during communication along the first pathway 106 between the node 102 and the network administrator, but not for charging a battery or other storage device of the node 102. For example, a separate charging station may be utilized to charge the battery or other storage device of the node 102. In some embodiments, the wireless transfer of energy from the network administrator 104 may be utilized for power to be used during communication along the first pathway 106 between the node 102 and the network administrator as well as for charging a battery or other storage device of the node 102 Also, in the illustrated embodiment, the second pathway 108 is configured for the communication of operational information between the node 102 and the network administrator 104. (As also indicated elsewhere herein, operational information as used herein may be understood as information exchanged between a node and a network administrator as part of the intended operation of the node, network, and/or system including the network or node, in contrast to information sent for the purpose of adding nodes to the network or removing nodes from the network, or other network management tasks.)

The first pathway 106 is configured for communication between the node 102 and the network administrator 104 at a relatively low frequency, for example a frequency configured for wireless inductive charging. In various embodiments, the first pathway 106 may be configured for communication at about 13 MHz or lower. As just one example, the first pathway may be configured for communication at about 13.56 MHz. The second pathway 108 may be configured for communication at higher frequencies, such as about 900 MHz, 2.4 GHz, or 5.8 GHz, among others.

In addition to differing frequencies, the first pathway 106 and the second pathway 108 may be characterized as having different ranges. For example, the node 102 and the network administrator 104 may be required to be within a first relatively short range of each other to communicate via the first pathway 106, while the node 102 and the network administrator 104 may be allowed to be within a longer range of each other to communicate via the second pathway 108. By way of example, the range (e.g., a permissible distance between the node 102 and the network administrator 104 for communication along a given pathway) of the first pathway 106 may be about 2 inches or about 5 centimeters, while the range of the second pathway 108 may be about 100 meters.

Further still, in various embodiments, the range of the first pathway 106 may define or otherwise correspond to a triggering for pairing (or un-pairing) of the node 102 and the network administrator 104 based on the proximity of the node 102 to the network administrator 104. For example, if the node 102 and the network administrator 104 are not paired or associated, the node 102 and the network administrator 104 may be brought into a position within the range of the first pathway 106 to trigger or initiate a pairing process. Conversely, if the node 102 and the network administrator 104 are already paired or associated, the node 102 and the network administrator 104 may be brought into a position within the range of the first pathway 106 to trigger or initiate an un-pairing or disassociation process. Additionally or alternatively, proximity information determined from the presence (or absence) of a node within the range of the first pathway 106 of a network administrator (or charging station) may also be utilized in conjunction with location-based functionality of the network 100. For example, when a node is within the range of the first pathway of an administrator, the location of the node may thus be determined and utilized in the control of the network 100. Further still, a status of a node (e.g., associated, disassociated, or charging) may be determined when the node is within the range of the first pathway 106 of an administrator or charging station and utilized in the control of the network 100.

In the illustrated embodiment, the node 102 includes a node processing module 110, a first communication module 112 (or first communication channel), a second communication module 120 (or second communication channel), a power management module 130, and a functional module 140. Generally, in various embodiments, the first communication module 112 is configured for communication with the network administrator 104 via the first pathway 106, and the second communication module 120 is configured for communication with the network administrator 104 via the second pathway 108. The power management module 130 is configured for storage and distribution of power to be used by other modules or aspects of the node 102, and the functional module 140 is configured to perform one or more functions during the operation of the node 102.

The node processing module 110 in the illustrated embodiment is configured as a central processing unit for the node 102. The node processing module 110, for example, may provide commands or control to other modules or aspects of the node 102. As just one example, in embodiments where the node 102 is configured as a sensing device, the node processing module 110 may receive information corresponding to one or more parameters that have been sensed from the functional module 140, and may provide corresponding information to the second communication module 120 to be used for transmission to the network administrator 104. The node processing module 110 may be configured as a central processing unit. In various embodiments, the node processing module may determine when the node 102 and the network administrator 104 are brought within a predetermined distance (e.g. a range of the first communication module 112 or the first pathway 106), and control the first communication module 112 to exchange network pairing information (e.g., authentication information) with the network administrator 104. Further, in various embodiments, the node processing module may determine when the node 102 and the network administrator 104 are brought within a predetermined distance and control the second communication module 120 to leave an energy conservation mode (e.g., a sleep mode) and enter an active mode.

In the illustrated embodiment, the first communication module 112 is configured for communication with the network administrator 104 via the first pathway 106. Thus, the first communication module 112 depicted in FIG. 1 may be understood as a low frequency communications channel. In various embodiments, the first communication module 112 is configured for low frequency communication with the network administrator 104 as well as for receiving a wireless charge from the network administrator 104.

The first communication module 112 of the illustrated embodiment includes a low frequency transmission member 114 and a low frequency transceiver 116. The low frequency transmission member 114 may be a near field RF coil. For example, the low frequency transmission member 114 may be configured for inductive charging with an induction coil that receives power from an electromagnetic field and converts the power from the electromagnetic field into electrical current to power the first communication module 112 and/or to charge the power management module 130. The low frequency transmission member 114 is also configured to send and receive signals along the first pathway 106 to and from the network administrator 104. For example, the low frequency transmission member 114 may send and receive network pairing information, such as authentication information, for pairing or un-pairing with the network administrator 104.

In various embodiments, the low frequency transceiver 116 may be configured as both a power transmitter and low frequency transceiver. For example, the low frequency transceiver 116 may receive control commands from the node processing module 110, may provide a signal for transmission via the low frequency transmission member 114, may obtain a signal that has been received by the low frequency transmission member 114, and/or transmit power received via the low frequency transmission member 114 (e.g., from a wireless charging station) to the power management module 130. The first communication module 112 may be configured to communicate over relatively short ranges. For example, in various embodiments, the first communication module 112 may be configured to communicate over a range of about 2 inches or about 5 centimeters or lower. Further, the first communication module 112 may be configured to communicate at relatively low frequencies. For example, in various embodiments, the first communication module 112 may be configured for communication at about 13.56 MHz or lower. In various alternate embodiments, the first communication module 112 may be configured for other types of wireless charging, such as capacitive charging, IR or ambient light charging, or ultrasonic charging, among others. In various embodiments, the first communication module 112 may be configured to implement a one or two way communication link to manage a battery charging process.

In the illustrated embodiment, the second communication module 120 is configured for communication with the network administrator 104 via the second pathway 108. Thus, the second communication module 120 depicted in FIG. 1 may be understood as a high frequency communications channel. In various embodiments, the second communication module 120 is configured for high frequency communication of operational information with the network administrator 104. The second communication module 120 of the illustrated embodiment includes a high frequency transmission member 122 and a high frequency transceiver 124. The high frequency transmission member 122 may be, for example, an antenna. The high frequency transmission member 122 is configured to send and receive signals along the second pathway 108 to and from the network administrator 104. For example, the high frequency transmission member 122 may send and receive operational information used or provided by the node 102 during operation as intended. For example, in various embodiments in which the node 102 is configured as a sensor, the operational information may include information corresponding to one or more parameters sensed or detected by the node 102. In various embodiments, the high frequency transceiver 124 may receive control commands from the node processing module 110, may provide a signal for transmission via the high frequency transmission member 122, and/or may obtain a signal that has been received by the high frequency transmission member 122.

The second communication module 120 may be configured to communicate over relatively long ranges. For example, in various embodiments, the second communication module 120 may be configured to communicate over a range of about 100 meters. Further, the second communication module 120 may be configured to communicate at relatively high frequencies. For example, in various embodiments, the second communication module 120 may be configured for communication at about 900 MHz or higher. As another example, in various embodiments, the second communication module 120 may be configured for communication at about 2.4 GHz or higher. As one more example, in various embodiments, the second communication module 120 may be configured for communication at about 5.8 GHz or higher.

Because, for example, the second communication module 120 is configured for longer range communication at higher frequencies, the second communication module 120 may be switchable between an energy conservation mode (such as sleep or idle) and an active mode. For example, when the node 102 is not currently paired with the network administrator 104 and is not in a current pairing process with the network administrator 104, the second communication module 120 may be placed in a sleep mode (e.g., a mode where insufficient energy to communicate via the second pathway 108 is received by the second communication module 120) to reduce energy used by the second communication module 120 from the power management module 130. However, for example, when the node 102 is brought within a predetermined distance of the network administrator 104 or, as additional examples a pairing process is otherwise initiated or successfully completed, the second communication module 120 may be transferred to an active mode. When the second communication module 120 is in the active mode, the second communication module 120 may be enabled to communicate via the second pathway 108.

In the illustrated embodiment, the power management module 130 includes a battery 132 and a battery charging circuit 134. Generally, in various embodiments, the power management module 130 is configured to receive energy, store energy, and distribute energy for use by other aspects of the node 102. For example, in the embodiment depicted in FIG. 1, the battery charging circuit 134 is configured to receive energy from the first communication module 112. As one example, energy wirelessly transferred in excess of energy required to operate all or a portion of the first communication module 112 from the network administrator 104 may be received by the battery charging circuit 134. As another example, energy wirelessly transferred from a charging station may be received by the battery charging circuit 134. The energy received via the battery charging circuit 134 may be stored in the battery 132, from where the energy may be distributed to other aspects of the node 102, such as the node processing module 110, the second communication module 120, and/or the functional module 140. Additional or alternate components may be employed in power management modules in various embodiments.

Generally, in various embodiments, the functional module 140 is configured to perform one or more tasks. For example, the functional module 140 may be configured to collect or obtain data, provide for adjustment of one or more aspects of the node 102, provide displays or other indications regarding the operation of the node 102, or the like. In the illustrated embodiment, the functional module 140 includes a settings module 142, a display module 144, and a sensor module 146.

The settings module 142, for example, may include buttons, switches, a keypad, or the like configured to allow one or more settings of the node 102 to be adjusted. For example, the settings module 142 may include a switch for powering the node 102 on or off. As another example, the settings module 142 may include a lock switch configured to prevent pairing or un-pairing, a security switch to set a level of security, or the like. As one more example, the settings module may have one or more dials or sliders to adjust a frequency of transmission or reception, a range of a communication module, or the like.

The display module 144 may be configured to display a status of the node 102. By way of example, statuses displayed may include network status, such as “On” (or “Paired) or “Off” (or “Un-Paired”), or operational status, such as “Sensing” or “Charging,” among others. The display module 144, for example, may include one or more light emitting diodes (LEDs) corresponding to statuses to be displayed. In various embodiments, the display module 144 may also include a screen or other display configured to provide a message to an operator, for example an explanation of why a pairing attempt may be unsuccessful (e.g. “cannot pair because already paired with different administrator”), and/or information identifying a particular network administrator 104 to which the node 102 is paired, for example.

The sensor module 146 may be configured to collect or obtain data to be shared with one or more network administrators. For example, the node 102 may be configured as a medical sensor for attachment to the body of a patient, and the sensor module 146 may be a sensor or detector configured to obtain data regarding the patient. The sensor or detector may detect, for example, one or more of a temperature, a pressure, an absorption of light, or an electrical charge, among others, associated with a patient. The sensor module 146 (and/or the node processing module 110) may be configured to filter, organize, or otherwise preprocess data collected before the data is transmitted to the network administrator. Additionally or alternatively, the functional module 140 may include other modules or sub-modules, such as a data entry module for the entry of data via keypad, touchscreen, bar code reader, or the like.

In the illustrated embodiment, the network administrator 104 may have an architecture that is generally similar to the architecture of the node 102 in certain respects. The network administrator 104 in the embodiment depicted in FIG. 1 differs from the node 102, for example, in that the depicted network administrator does not include a sensor module, and also in that the depicted network administrator includes a processing and display module 190 configured to process and display information received from one or more nodes.

In the illustrated embodiment, the network administrator 104 includes a network administrator processing module 150, a first communication module 152 (or first communication channel), a second communication module 160 (or second communication channel), a power management module 170, a functional module 180, and a processing and display module 190. Generally, in various embodiments, the first communication module 152 is configured for communication with the node 102 via the first pathway 106, and the second communication module 160 is configured for communication with the node 102 via the second pathway 108. The power management module 170 is configured for storage and distribution of power to be used by other modules or aspects of the network administrator 104, and the functional module 180 is configured to perform one or more functions during the operation of the network administrator 104.

The network administrator processing module 150 in the illustrated embodiment is configured as a central processing unit for the network administrator 104. The network administrator processing module 150, for example, may provide commands or control to other modules or aspects of the network administrator 104. The network administrator processing module 150 may be configured as a central processing unit. In various embodiments, the network administrator processing module 150 may determine when the node 102 and the network administrator 104 are brought within a predetermined distance (e.g. a range of the first communication module 152 or the first pathway 106), and control the first communication module 152 to exchange network pairing information (e.g., authentication information) with the node 102. Further, in various embodiments, the network administrator processing module 150 may determine when the node 102 and the network administrator 104 are brought within a predetermined distance (and when the network administrator 104 is not paired with any other nodes) and control the second communication module 160 to leave an energy conservation mode (e.g., a sleep mode) and enter an active mode.

In the illustrated embodiment, the first communication module 152 is configured for communication with the network administrator 104 via the first pathway 106. Thus, the first communication module 152 depicted in FIG. 1 may be understood as a low frequency communications channel. The first communication module 152 may be configured to communicate with the first communication module 112 of the node 102, and may be configured generally similarly in respects to the first communication module 112 of the node 102. In various embodiments, the first communication module 152 is configured for low frequency communication with the node 102 as well as for providing wirelessly transmitted energy from the network administrator 104 to the node 102. The wirelessly transmitted energy may be utilized for operating the first communication module 112 of the node 102 and/or for charging the power management module 130 of the node 102. In some embodiments, the first communication module 152 may also be configured to receive energy wirelessly from a charging station, while in other embodiments the first communication module 152 of the network administrator 104 may be configured to transmit but not receive energy wirelessly.

The first communication module 152 of the illustrated embodiment includes a low frequency transmission member 154 and a low frequency transceiver 156. The low frequency transmission member 154 may, for example, be configured as a near field RF coil that converts current (e.g., current supplied from the power management module 170) into an electromagnetic field for inductive charging of the node 102. The low frequency transmission member 154 is also configured to send and receive signals along the first pathway 106 to and from the node 102. For example, the low frequency transmission member 114 may send and receive network pairing information, such as authentication information, for pairing or un-pairing with the node 102. In various embodiments, the low frequency transceiver 156 may be configured as both a power transmitter and low frequency transceiver. For example, the low frequency transceiver 156 may receive control commands from the network processing module 150, may provide a signal for transmission via the low frequency transmission member 154, may obtain a signal that has been received by the low frequency transmission member 154, and/or transmit power from the power management module 170 to the low frequency transmission member 154 for wireless power supply to the node 102.

The first communication module 152 may be configured to communicate over relatively short ranges. For example, in various embodiments, the first communication module 152 may be configured to communicate over a range of about 2 inches or about 5 centimeters or lower. Further, the first communication module 152 may be configured to communicate at relatively low frequencies. For example, in various embodiments, the first communication module 152 may be configured for communication at about 13.56 MHz or lower. In various alternate embodiments, the first communication module 152 may be configured for other types of wireless energy transfer, such as capacitive charging, IR or ambient light charging, or ultrasonic charging, among others.

In the illustrated embodiment, the second communication module 160 is configured for communication with the node 102 via the second pathway 108. Thus, the second communication module 160 depicted in FIG. 1 may be understood as a high frequency communications channel. The second communication module 160 may be configured to communicate with the second communication module 120 of the node 102, and may be configured generally similarly in respects to the second communication module 120 of the node 102. In various embodiments, the second communication module 160 is configured for high frequency communication of operational information with the node 102. In various embodiments, the second communication module 160 of the network administrator 104 and the second communication module 120 of the node 102 may also exchange authentication information via the second pathway 108.

The second communication module 160 of the illustrated embodiment includes a high frequency transmission member 162 and a high frequency transceiver 164. The high frequency transmission member 162 may be, for example, an antenna. The high frequency transmission member 162 is configured to send and receive signals along the second pathway 108 to and from the node 102. For example, the high frequency transmission member 162 may send and receive operational information used or provided by the network administrator 104 during operation as intended. For example, in various embodiments in which the node 102 is configured as a sensor and the network administrator 104 as a monitor, the operational information may include information corresponding to one or more parameters sensed or detected by the node 102 that is transmitted to the network administrator 104. Further, the operational information may include one or more settings or control commands provided by the network administrator 104 acting as a monitor to the node 102 acting as a sensor. In various embodiments, the high frequency transceiver 164 may receive control commands from the network administrator processing module 150, may provide a signal for transmission via the high frequency transmission member 162, and/or may obtain a signal that has been received by the high frequency transmission member 162.

The second communication module 160 may be configured to communicate over relatively long ranges. For example, in various embodiments, the second communication module 160 may be configured to communicate over a range of about 100 meters. Further, the second communication module 160 may be configured to communicate at relatively high frequencies. By way of example, in various embodiments, the second communication module 160 may be configured for communication at about 900 MHz or higher, at about 2.4 GHz or higher, or at about 5.8 GHz or higher, among others. Because, for example, the second communication module 160 is configured for longer range communication at higher frequencies, the second communication module 160 may be switchable between an energy conservation mode (such as sleep or idle) and an active mode. For example, when the network administrator 104 is not currently paired with any nodes and is not in a current pairing process with any nodes, the second communication module 160 may be placed in a sleep mode. However, when the node 102 is brought within a predetermined distance of the network administrator 104 or a pairing process is otherwise initiated, the second communication module 160 may be transferred to an active mode. When the second communication module 160 is in the active mode, the second communication module 160 may be enabled to communicate with the second communication module 112 of the node 102 via the second pathway 108.

In the illustrated embodiment, the power management module 170 includes an energy supply module 172 and a battery charging circuit 174. Generally, in various embodiments, the power management module 170 is configured to provide and/or receive energy, store energy, and distribute energy for use by other aspects of the network administrator 104. For example, in the embodiment depicted in FIG. 1, the battery charging circuit 174 is configured to receive energy from the energy supply module 172 and to provide energy to the first communication module 152 for wireless transmission of energy to the node 102, as well as to provide power to the first communication module 152. In various embodiments, the energy supply module 172 may be configured to receive energy from an external source, such as via an AC wall outlet, and to provide energy to other aspects of the network administrator 104, such as the network administrator processing module 150, the first communication module 152, the second communication module 160, the functional module 180, and/or the processing and display module 190. In other embodiments, the energy supply module 172 may be configured as a battery, and energy for charging the battery received wirelessly from a charging station may be provided by the first communication module 152 to the power management module 170, and received by the battery charging circuit 174. Additional or alternate components may be employed in power management modules in various embodiments.

Generally, in various embodiments, the functional module 180 is configured to perform one or more tasks. For example, the functional module 180 may be configured to collect or obtain data, provide for adjustment of one or more aspects of the network administrator 104, provide displays or other indications regarding the operation of the network administrator 104, or the like. In the illustrated embodiment, the functional module 180 includes a settings module 182 and a display module 184. The settings module 182, for example, may include buttons, switches, a keypad, or the like configured to allow one or more settings of the network administrator 104 to be adjusted. The display module 184 may be configured to display a status of the network administrator 104. By way of example, statuses displayed may include network status or operational status, among others. The display module 184, for example, may include one or more light emitting diodes (LEDs) corresponding to statuses to be displayed. In various embodiments, the display module 184 may also include a screen or other display configured to provide a message to an operator, for example an explanation of why a pairing attempt may be unsuccessful (e.g. “cannot pair because node attempting to pair is already paired with different administrator”), and/or information identifying one or more nodes to which the network administrator 104 is currently paired, for example.

In various embodiments, the processing and display module 190 is configured to process data obtained from nodes and provide a corresponding display to a user. The processing and display module 190 may provide the corresponding display to other devices or systems, may provide a print-out, may store results for later analysis, and/or may provide a visual display on a screen. For example, in various embodiments, the network administrator 104 may be configured as a monitor that receives patient information corresponding to measured parameters of a patient provided by one or more nodes. The processing and display module 190 of the network administrator 104 may then utilize the information provided by the nodes to provide a display used by a practitioner, such as a display showing one or more of heart rate, blood pressure, or oxygen concentration, among others.

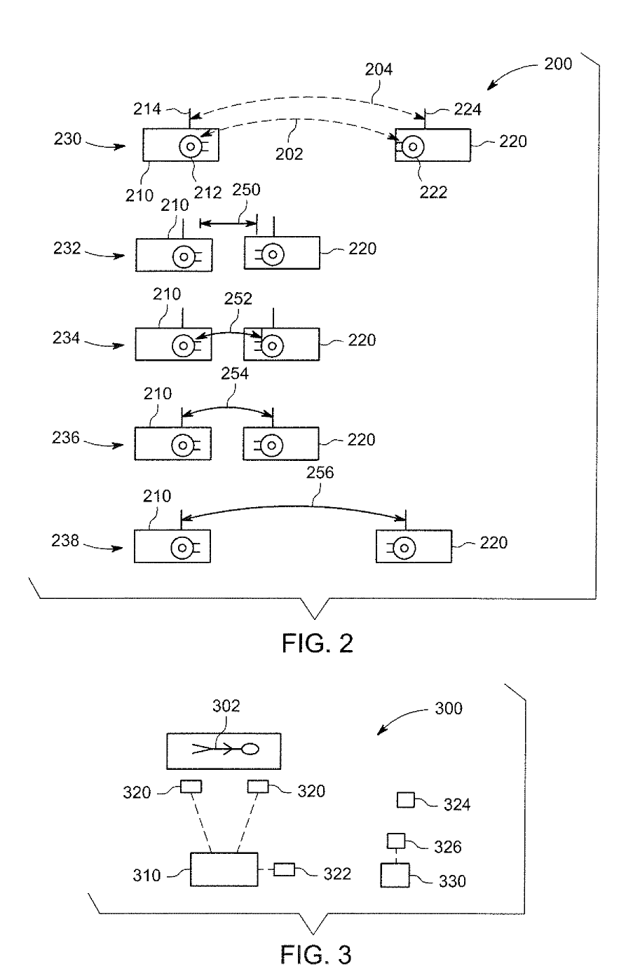

FIG. 2 is a flow diagram depicting the pairing of and communication between a coordinator and a node in accordance with various embodiments. FIG. 2 depicts a system 200 including a coordinator 210 and a node 220. The coordinator 210 may be generally similar in certain respects to the network administrator 104 discussed in connection with FIG. 1, and the node 220 may be generally similar in certain respects to the node 102 discussed in connection with FIG. 1. The coordinator 210 may include a first antenna 212 and a second antenna 214. Also, the node 220 may include a first antenna 222 and a second antenna 224. The first antenna 212 of the coordinator 210 and the first antenna 222 of the node 220 may be configured to include a primary coil, and configured to wirelessly transmit power as well as information between the first antenna 212 and the first antenna 222. The first antenna 212 and the first antenna 222 may be configured to communicate at a relatively low data rate, such as about 13 MHz. The second antenna 214 of the coordinator 210 and the second antenna 224 of the node 220 may be configured for communication therebetween at a relatively higher data rate, such as about 2.4 GHz. Thus, the coordinator 210 and the node 220 may communicate via a first pathway 202 using the first antennas 212, 222, and via a second pathway 204 using the second antennas 214, 224.

At 230, the coordinator 210 and the node 220 are depicted as being positioned a distance apart, and are not associated within a common network. Thus, the coordinator 210 and the node 220 are not joined or paired, and are not exchanging information via either the first pathway 202 or the second pathway 204. In the illustrated embodiment, radios and/or other equipment associated with the second antennas 214, 224 may be turned off or positioned in a sleep mode to conserve energy at 230. In various embodiments, the coordinator 210 may be paired with other nodes (not shown), and the second antenna 214 of the coordinator 224 may be turned on or in an active mode.

At 232, the node 220 is brought within a range 250 of the coordinator 210. The range 250 may be defined by the range of the first antennas 212, 222 over the first pathway 202. In various embodiments, the first antennas 212, 222 may be configured for inductive charging, and the range 250 may be about 2 inches or about 5 centimeters. The coordinator 210 and/or the node 220 may be configured to detect when the coordinator 210 and the node 220 are within the range 250 of each other, and be configured to automatically or autonomously initiate a pairing process to pair the node 220 to the coordinator 210.

At 234, with the coordinator 210 and the node 220 within the range 250 of each other, the coordinator 210 and the node 220 exchange network pairing information 252 via the first antennas 212, 222 along the first pathway 202. For example, the coordinator 210 and the node 220 may exchange one or more of unique keys, frequency information specifying one or more frequencies for communication between the coordinator 210 and the node 220, other settings information, or the like. In some embodiments, radios or other equipment associated with the second pathway 204 (e.g., associated with the second antenna 224 and/or the second antenna 214) may be switched from a sleep or energy conservation mode responsive to an exchange of pairing information between the node 220 and the coordinator 210. In some embodiments, radios or other equipment associated with the second pathway 204 (may be switched from a sleep or energy conservation mode responsive to the node 220 being brought within the range 250 of the coordinator 210.

At 236, the coordinator 210 and the node 220 exchange network pairing information 254 via the second antennas 214, 224 along the second pathway 204. For example, the coordinator 210 and the node 220 may exchange one or more of unique keys, frequency information specifying one or more frequencies for communication between the coordinator 210 and the node 220, other settings information, or the like. Thus, in the embodiment depicted in FIG. 2, network pairing information is exchanged at a first lower frequency via the first pathway 202 and also exchanged subsequently at a second higher frequency via the second pathway 204. In various embodiments, for example, network pairing information may be exchanged at the lower frequency along the first pathway 202, and not at the higher frequency along the second pathway 204.

At 238, with the coordinator 210 and the node 220 paired and configured for communication along the second pathway 204, the coordinator 210 and the node 220 may be separated by a distance greater than the range 250, and may exchange operational information 256 via the second antennas 214, 224 via the second pathway 204. The second pathway 204, for example, may be configured communication over a substantially larger range than the first pathway 202. For example, the second pathway 204 may be configured for communication over a range of about 100 meters or longer in some embodiments. In some embodiments, the node 220 may be configured as a sensor to detect or sense a parameter of a medical patient or a physical environment, among other things, and the operational information may include data or information corresponding to the sensed parameter. As another example, in some embodiments, the node 220 may be configured as a data entry device. The node 220, for example, may include one or more of a keypad, touchscreen, or automated reader such as a bar code reader, among others, and information corresponding to data entered or selections made by an operator utilizing the node 220 may be transmitted as all or a portion of the operational information.

In various embodiments, the node 220 may be un-paired from the coordinator 210 by bringing the paired node 220 back within the range 250 of the coordinator 210. With the node 220 back within the range 250 of the coordinator 210, an un-pairing process may be automatically or autonomously initiated. Thus, in various embodiments, a proximity between a node and a coordinator may be used in conjunction with the initiation and/or performance of pairing and un-pairing. For example, exchanging authentication information over the relatively shorter range of the first pathway 202 may prevent human error while still leaving a higher frequency channel free to communicate without interference from the pairing process, and, because of the shorter range utilized for authentication, inadvertent pairing or un-pairing as well as malicious invasion may be reduced or eliminated. Further still, as a low frequency channel may be used both for authentication and wireless charging, the number of components, cost, and/or amount of board space or other space utilized may be reduced in comparison to systems that may use a separate dedicated authentication channel, such as via near field communications (NFC).

FIG. 3 is a schematic view of a network 300 for monitoring parameters of a patient 302 in accordance with various embodiments. The network 300 includes a monitor 310, paired sensors 320, a pairing sensor 322, an unpaired sensor 324, a charging sensor 326, and a charging station 330. The monitor 310 in the illustrated embodiment is configured as a network administrator and the various sensors 320, 322, 324, and 326 as nodes that may associate and dis-associated (or pair and un-pair) with the network administrator (the monitor 310). In various embodiments, the network 300 may include additional monitors (not shown), with each monitor having associated therewith a dedicated network or sub-network. For example, each monitor may be associated with a given patient, and any sensor to be used for that particular patient may be first paired to the monitor. To use the sensor with a different patient, the sensor may be un-paired from the monitor, and then subsequently paired with a monitor associated with the different patient. In the illustrated embodiment, each of the sensors may be configured to measure, sense, or detect one or more parameters of the patient 302, such as blood pressure, heart rate, oxygen concentration, or the like. The sensors may then provide their data to the monitor 310, which may be configured to further process the data and/or provide a display corresponding to the well-being or health of the patient.

In FIG. 3, the paired sensors 320 have already been paired with the monitor 310 and are positioned on or near the patient 302 to collect information regarding the patient and transmit the information to the monitor 310. The information regarding the patient may be transmitted to the monitor via a high frequency channel. The pairing sensor 322 is depicted as being positioned proximate the monitor 310, and is in the process of being paired with the monitor 310. In some embodiments, the pairing process may be triggered automatically based on the presence of the pairing sensor 322 within a range of the monitor 310 (e.g., within a range of an inductive charging low frequency channel). In other embodiments, the pairing process may be triggered via use of a push button, for example. Using a proximity instead of a push button for triggering the pairing process as shown in FIG. 3 helps reduce sterilization issues associated with the use of push buttons.

During the pairing process, the pairing sensor 322 and the monitor 310 exchange network pairing information. For example, the monitor 310 and the pairing sensor 322 may be identified by unique keys, and exchange the keys with each other. Other information, such as information from the pairing sensor 322 to the monitor 310 identifying the particular pairing sensor 322, the type of pairing sensor 322, the capabilities of the pairing sensor 322, or the like may be exchanged. Also, information from the monitor 310 regarding settings for use with the pairing sensor 322 may be provided during the pairing process as well. Once the monitor 310 and the pairing sensor 322 have been authenticated to each other, the pairing sensor 322 may be paired to the monitor 310 and may be considered a paired sensor 320, and positioned as desired to collect information regarding the patient 302 and to transmit the information to the monitor 310 via the high frequency channel. It may be noted that use of the low frequency channel during pairing may help to prevent or reduce interference with operational information being transmitted from sensors already paired to the monitor 310.

An unpaired sensor 324 and a charging sensor 326 are also depicted in FIG. 3. To pair the unpaired sensor 324 to the monitor 310, the unpaired sensor 324 may be brought within the predetermined range to trigger pairing. Conversely, to un-pair one of the paired sensors 320 from the monitor, the particular paired sensor 320 to be un-paired may be brought within the predetermined range or proximity of the monitor 310 to trigger an un-pairing process. In FIG. 3, the charging sensor 326 has been brought within a predetermined range of the charging station 330. The charging sensor 326 and the charging station 330 may communicate via the low frequency inductive charging channel to identify each other, and, if successfully identified or authenticated to each other, the charging station 330 may wireless transmit power (e.g., via inductive charging) to the charging sensor 326. Once charged, the charging sensor 326 may be brought within the predetermined range of the monitor 310 for pairing to the monitor 310. In various embodiments, the various sensors may be configured for pairing with only one monitor at a time, to help insure that patient information is not inadvertently sent to an incorrect monitor. For example, when paired a sensor may set a network status or state to “On” or “Paired.” When brought within range of a different monitor, the sensor may then be configured to be unable to pair with a different monitor than the one to which the sensor is already paired. An error light, message, or other indication may be provided to indicate to a user that the sensor must first be un-paired from a different monitor before pairing with the desired monitor may be accomplished. Further still, information regarding the particular monitor or charging station to which a sensor is paired or to which a sensor is proximate (e.g., within the predetermined range) may be tracked by the network 300 and used in conjunction with location based content or control.

Modules discussed herein may be understood in various embodiments as being configured as or including a processing module. A processing module may be configured as one or more computer processors or other logic-based devices that perform operations based on one or more sets of instructions (e.g., software). The instructions on which the processing module operates may be stored on a tangible and non-transitory (e.g., not a transient signal) computer readable storage medium, such as a memory that is a part of, accessible by, or otherwise associated with the processing module. The memory may include one or more computer hard drives, flash drives, RAM, ROM, EEPROM, and the like. Alternatively, one or more of the sets of instructions that direct operations of the processing module may be hard-wired into the logic of the processing module, such as by being hard-wired logic formed in the hardware of the processing module.

It should be noted that the particular arrangement of components (e.g., the number, types, placement, or the like) of the illustrated embodiments may be modified in various alternate embodiments. In various embodiments, different numbers of a given module or unit may be employed, a different type or types of a given module or unit may be employed, a number of modules or units may be combined, a given module or unit may be divided into plural modules (or sub-modules) or units (or sub-units), a given module or unit may be added, or a given module or unit may be omitted.

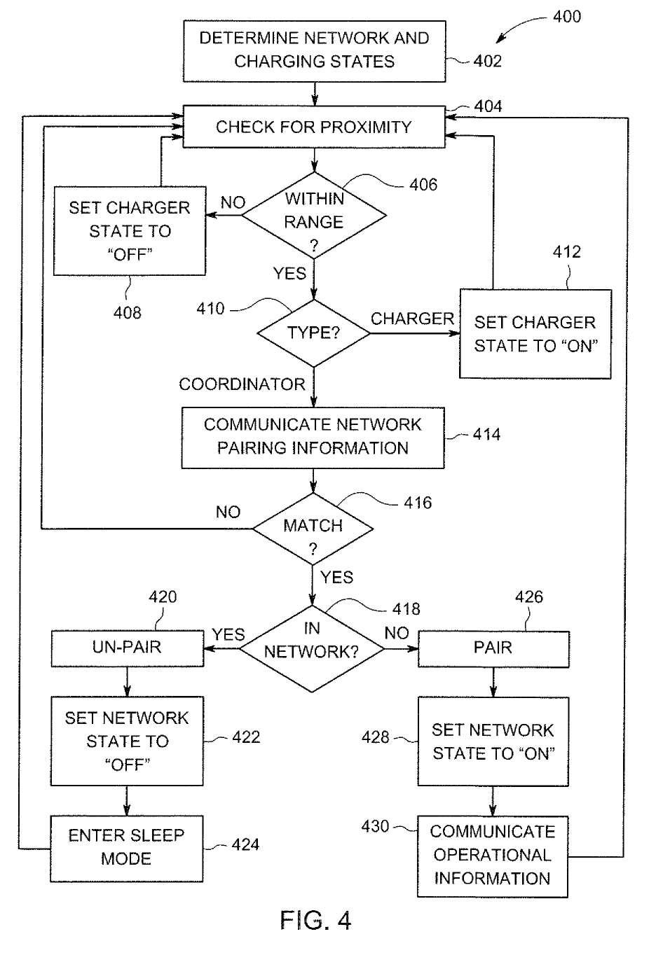

FIG. 4 is a flowchart of a method for operating a node in accordance with various embodiments. In various embodiments, the method 400, for example, may employ structures or aspects of various embodiments (e.g., systems and/or methods) discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion.

At 402, network and/or charging states of a node may be determined. For example, if the node is not currently paired with a network administrator (or gateway), the network status may be “Off” or “Un-Paired,” while if the node is currently paired with a network administrator, the network status may be “On” or “Paired.” Further, in various embodiments, when the node is paired to a network administrator, information identifying the particular network administrator to which the node is paired may be stored. If the node is proximate a charging station and/or receiving charging energy, the charging status may be set to “On” or “Charging” while the charging status may be set to “Off” or “Not Charging” if not proximate a charging station or receiving charging energy.

At 404, the proximity of the node to a network administrator or other network element, such as a charger, may be determined. For example if the node is within a predetermined range (e.g., a range of wireless charging circuitry associated with the node and/or network element), the node may be considered as proximate to the network element. The proximity may be determined, for example, by a processing module of the node. The proximity in various embodiments may be checked periodically.

At 406, it is determined if the node is proximate to a network element based on the proximity checked at 404. If the node is not proximate to a network element, the method 400 proceeds to 408. At 408, the charger status is set to “Off” if not already set at “Off.” The method 400 next proceeds to 404 for continued periodic proximity checks.

If, at 406, it is determined that the node is proximate to a network element, the method proceeds to 410. It may be noted that the determination if the node is proximate to or within a range of a network element may be understood as one technique or way of identifying or selecting a network element for pairing or un-pairing with the node. Other techniques or ways of identifying or selecting a network element for pairing or un-pairing may be employed in various embodiments. At 410, the type of network element is determined. In the embodiment depicted in FIG. 4, the types of network element may be a network administrator (or gateway), or charger.

At 410, the type of network element to which the node is proximate is determined. The determination may be made for example, based on a signal or information transmitted over an inductive charging channel from the network element to the node. The determination may be made, for example, by a processing module of the node. If the network element is identified or determined as being a charger or charging station, the method 400 proceeds to 412, where the charging status or state is set to “On” and charging may take place via the inductive charging channel. The method 400 may then return to 404 for continued periodic proximity checks.

If, at 410, if the type of network element is determined to be a network administrator or gateway, the method 400 proceeds to 414, where network pairing information is communicated between the node and the network administrator. The network pairing information may be exchanged over the inductive charging channel (or other wireless charging channel). In various embodiments, the network pairing information may be transmitted over the inductive charging channel at a relatively low frequency, such as, for example, about 13 MHZ or lower. In various embodiments, the network administrator may have a unique key and the node may also have a unique key, and the unique keys may be exchanged as part of the communication of network pairing information. Additional information, such as settings and/or frequencies to be used for future communication (via the inductive charging channel and/or via a high frequency communication channel) may also be communicated via the node and the network administrator. For example, in various embodiments, the node and network administrator may exchange a unique identification number for each using the inductive charging channel. Then, the node and network administrator may exchange messages over a second channel (e.g., a high-frequency operational communication channel) using the unique identification numbers to authenticate each other as well as to subsequently encrypt data traffic.

At 416, it is determined if the network pairing information is matched, or if the node and network administrator are authenticated to each other. The determination may be made by one or more processing modules disposed onboard the node and/or network administrator. If one or both keys are not recognized, for example, the network pairing information may be determined not to match. As another example, in various embodiments where it may be undesirable for a given node to pair with more than one network administrator, the network pairing information may be determined not to match if the node is already paired with a different administrator. If it is determined the information does not match, the method 400 returns to 404 for periodic proximity checks. In some embodiments, an indication or description of the failure to match and/or explanation of why the match was not made may be provided to a user. If the network pairing information is determined to match, the method proceeds to 418.

At 418, it is determined if the node is in the network or already paired or joined to the network administrator. If the node is determined to be currently paired to the network administrator, the method 400 proceeds to 420 for un-pairing, and if the node is determined not to be paired to the network administrator (and, in some embodiments, not paired to any other network administrator), the method 400 proceeds to 426 for pairing.

At 420, un-pairing is initiated. The un-pairing may be initiated and performed pursuant to any particular guidelines of a communication protocol employed by the node and the network administrator. If the un-pairing is successful, the method proceeds to 422, where the network status or state is set to “Off.” In various embodiments, a high frequency communication channel (e.g., 900 MHz or higher) of the node may be placed in a sleep or other energy conservation mode responsive to the un-pairing of the node from the network administrator. The method 400 may then return to 404 for periodic proximity checks.

If, at 418 it is determined that the node and the network are not paired, the method 400 may proceed to 426. At 426, the node and the network administrator are paired. The pairing may be initiated and performed pursuant to any particular guidelines of a communication protocol employed by the node and the network administrator. At 428, if the paring is successful, the network status or state is set to “On.” In various embodiments, the high frequency communication channel may be transferred from a sleep or other energy conservation mode to an active state. At 430, with the node and the network administrator paired, operational information may be communicated between the node and the network administrator. The operational information may include information detected, sensed, entered, or otherwise obtained at or by the node, and/or may include control or settings commands or directions provided by the network administrator to the node. The operational information may be transmitted using the high frequency channel or pathway. The method 400 may also return to 404 for periodic proximity checks.

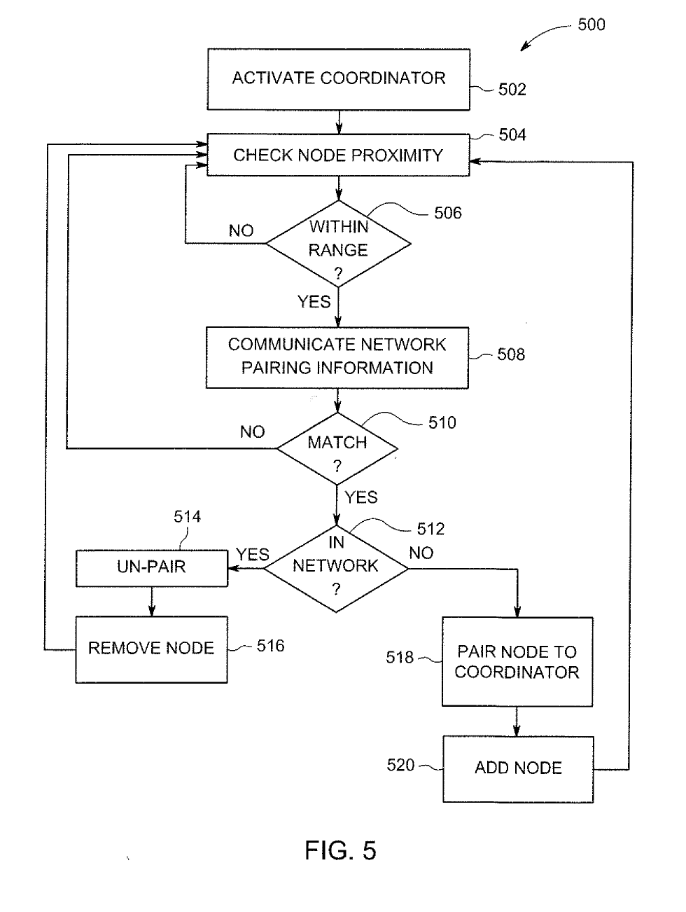

FIG. 5 is a flowchart of a method for operating a network coordinator in accordance with various embodiments. In various embodiments, the method 500, for example, may employ structures or aspects of various embodiments (e.g., systems and/or methods) discussed herein. In various embodiments, certain steps may be omitted or added, certain steps may be combined, certain steps may be performed simultaneously, certain steps may be performed concurrently, certain steps may be split into multiple steps, certain steps may be performed in a different order, or certain steps or series of steps may be re-performed in an iterative fashion.

At 502, a network coordinator is activated. The network coordinator for example, may be brought from an “Off” or “Sleep” mode or state to an active state. At 504, it is determined if a node is within proximity of the network administrator. For example, if an object or element is detected as being proximate to the network administrator, it may be determined (for example, by a processing module of the network administrator using information provided by the object or element) if the object or element is a node. For example if the node is within a predetermined range (e.g., a range of wireless charging circuitry associated with the node and/or network element), the node may be considered as proximate to the network element. The proximity may be determined, for example, by a processing module of the network administrator. The proximity in various embodiments may be checked periodically.

At 506, it is determined if the node is proximate to the network administrator, or within the predetermined range of the network administrator based on the proximity checked at 504. If a node is not proximate to a network element, the method 500 may return 504 for continued periodic proximity checks.

If, at 506, it is determined that a node is proximate to a network element, the method proceeds to 508. It may be noted that the determination if the node is proximate to or within a range of a network element may be understood as one technique or way of identifying or selecting a node for pairing or un-pairing with the network element. Other techniques or ways of identifying or selecting a node for pairing or un-pairing may be employed in various embodiments.

At 508, network pairing information is communicated between the node and the network administrator. The network pairing information may be exchanged over a wireless charging channel, such as an inductive charging channel. In various embodiments, the network pairing information may be transmitted over the inductive charging channel at a relatively low frequency, such as, for example, about 13 MHZ or lower. In various embodiments, the network administrator may have a unique key and the node may also have a unique key, and the unique keys may be exchanged as part of the communication of network pairing information. Additional information, such as settings and/or frequencies to be used for future communication (via the inductive charging channel and/or via a high frequency communication channel) may also be communicated via the node and the network administrator. For example, in various embodiments, the node and network administrator may exchange a unique identification number for each using the inductive charging channel. Then, the node and network administrator may exchange messages over a second channel (e.g., a high-frequency operational communication channel) using the unique identification numbers to authenticate each other as well as to subsequently encrypt data traffic.

At 510, it is determined if the network pairing information is matched, or if the node and network administrator are authenticated to each other. The determination may be made by one or more processing modules disposed onboard the node and/or network administrator. If one or both keys are not recognized, for example, the network pairing information may be determined not to match. As another example, in various embodiments where it may be undesirable for a given node to pair with more than one network administrator, the network pairing information may be determined not to match if the node is already paired with a different administrator. If it is determined the information does not match, the method 500 returns to 504 for periodic proximity checks. In some embodiments, an indication or description of the failure to match and/or explanation of why the match was not made may be provided to a user. If the network pairing information is determined to match, the method 500 proceeds to 512.

At 512, it is determined if the node is in the network or already paired or joined to the network administrator. For example, an identification or listing of all nodes currently joined or paired to the network administrator may be stored onboard or accessible by the network administrator, and a processing module of the network administrator may determine based on the list if the particular node is currently paired or not paired to the network administrator. If the node is determined to be currently paired to the network administrator, the method 500 proceeds to 514 for un-pairing, and if the node is determined not to be paired to the network administrator (and, in some embodiments, not paired to any other network administrator), the method 500 proceeds to 518 for pairing.

At 514, un-pairing is initiated. The un-pairing may be initiated and performed pursuant to any particular guidelines of a communication protocol employed by the node and the network administrator. If the un-pairing is successful, the method 500 proceeds to 516, where the node is removed from the network of the network administrator. In some embodiments, an identification of the node may be removed from a list of nodes identified as currently paired or joined with the network administrator stored by the network administrator and used in connection with the determination at 512. The method 500 may then return to 504 for periodic proximity checks.

If, at 512 it is determined that the node and the network are not paired, the method 500 may proceed to 518. At 518, the node and the network administrator are paired. The pairing may be initiated and performed pursuant to any particular guidelines of a communication protocol employed by the node and the network administrator. At 518, if the paring is successful, the node may be added to the network. In some embodiments, an identification of the node is added to a list of nodes currently paired or joined with the network for use in connection with the determination at 512. Further, with the node paired with the network, operational information may be communicated between the node and the network administrator. The operational information may include information detected, sensed, entered, or otherwise obtained at or by the node, and/or may include control or settings commands or directions provided by the network administrator to the node. The operational information may be transmitted using the high frequency channel or pathway (e.g., a pathway distinct from a wireless charging channel, and configured for communication at, for example, 900 MHz or above). The method 500 may also return to 504 for periodic proximity checks.

Thus, various embodiments provide for the addition of a node to or the removal of a node from a network with reduced or eliminated interference to operation of the network or data collection. Various embodiments also provide for the additional or removal of a node to a network in a reliable manner that reduces human involvement and helps ensure that the intended pairing is made. Additionally, various embodiments provide for improved security when adding nodes to or removing nodes from a network. Further still, various embodiments provide for savings in terms of space, weight, cost of materials, or cost to build, among others. Yet further still, in various embodiments, a system of network management and location services may be provided having the ability to detect and/or track the location of a particular location of a node based on wireless charging circuitry with which the node comes into contact, such as a charging pad or station, or, as another example, a network administrator.

It should be noted that the various embodiments may be implemented in hardware, software or a combination thereof. The various embodiments and/or components, for example, the modules, or components and controllers therein, also may be implemented as part of one or more computers or processors. The computer or processor may include a computing device, an input device, a display unit and an interface, for example, for accessing the Internet. The computer or processor may include a microprocessor. The microprocessor may be connected to a communication bus. The computer or processor may also include a memory. The memory may include Random Access Memory (RAM) and Read Only Memory (ROM). The computer or processor further may include a storage device, which may be a hard disk drive or a removable storage drive such as a solid state drive, optical drive, and the like. The storage device may also be other similar means for loading computer programs or other instructions into the computer or processor.

As used herein, the term “computer,” “controller,” and “module” may each include any processor-based or microprocessor-based system including systems using microcontrollers, reduced instruction set computers (RISC), application specific integrated circuits (ASICs), logic circuits, GPUs, FPGAs, and any other circuit or processor capable of executing the functions described herein. The above examples are exemplary only, and are thus not intended to limit in any way the definition and/or meaning of the term “module” or “computer.”

The computer, module, or processor executes a set of instructions that are stored in one or more storage elements, in order to process input data. The storage elements may also store data or other information as desired or needed. The storage element may be in the form of an information source or a physical memory element within a processing machine.

The set of instructions may include various commands that instruct the computer, module, or processor as a processing machine to perform specific operations such as the methods and processes of the various embodiments described and/or illustrated herein. The set of instructions may be in the form of a software program. The software may be in various forms such as system software or application software and which may be embodied as a tangible and non-transitory computer readable medium. Further, the software may be in the form of a collection of separate programs or modules, a program module within a larger program or a portion of a program module. The software also may include modular programming in the form of object-oriented programming. The processing of input data by the processing machine may be in response to operator commands, or in response to results of previous processing, or in response to a request made by another processing machine.

As used herein, the terms “software” and “firmware” are interchangeable, and include any computer program stored in memory for execution by a computer, including RAM memory, ROM memory, EPROM memory, EEPROM memory, and non-volatile RAM (NVRAM) memory. The above memory types are exemplary only, and are thus not limiting as to the types of memory usable for storage of a computer program. The individual components of the various embodiments may be virtualized and hosted by a cloud type computational environment, for example to allow for dynamic allocation of computational power, without requiring the user concerning the location, configuration, and/or specific hardware of the computer system.

It is to be understood that the above description is intended to be illustrative, and not restrictive. For example, the above-described embodiments (and/or aspects thereof) may be used in combination with each other. In addition, many modifications may be made to adapt a particular situation or material to the teachings of the invention without departing from its scope. Dimensions, types of materials, orientations of the various components, and the number and positions of the various components described herein are intended to define parameters of certain embodiments, and are by no means limiting and are merely exemplary embodiments. Many other embodiments and modifications within the spirit and scope of the claims will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Moreover, in the following claims, the terms “first,” “second,” and “third,” etc. are used merely as labels, and are not intended to impose numerical requirements on their objects. Further, the limitations of the following claims are not written in means-plus-function format and are not intended to be interpreted based on 35 U.S.C. §112, sixth paragraph, unless and until such claim limitations expressly use the phrase “means for” followed by a statement of function void of further structure.

This written description uses examples to disclose the various embodiments, and also to enable a person having ordinary skill in the art to practice the various embodiments, including making and using any devices or systems and performing any incorporated methods. The patentable scope of the various embodiments is defined by the claims, and may include other examples that occur to those skilled in the art. Such other examples are intended to be within the scope of the claims if the examples have structural elements that do not differ from the literal language of the claims, or the examples include equivalent structural elements with insubstantial differences from the literal languages of the claims.

What is claimed is:

1. A system comprising:
a first network member comprising:
a first channel configured as a charging channel, the first channel configured to at least one of wirelessly receive or transmit power, the first channel also configured to transmit network pairing information for at least one of pairing or un-pairing the first network member and a second network member, the network pairing information transmitted over the first channel at a first frequency; and
a second channel configured as an operational channel, the second channel configured to communicate operational information between the first and second network members when the first and second network members are paired, the operational information transmitted over the second channel at a second frequency that is different than the first frequency.

2. The system of claim 1, wherein the first network member is configured to initiate transmitting network pairing information via the first channel based on a detected proximity of the first network member to the second network member.

3. The system of claim 2, wherein the first network member is configured to un-pair from the second network member when the first and second network members are brought within a predetermined distance when the first and second network members are paired.

4. The system of claim 2, wherein the first network member is configured to pair with the second network member when the first and second network members are brought within a predetermined distance when the first and second network members are not paired.

5. The system of claim 1, wherein the first network member is configured as a network coordinator.

6. The system of claim 1, wherein the first network member is configured as a network node.

7. The system of claim 1, further comprising plural second network members, wherein the first network member is configured as a monitor for a medical monitoring system, wherein the plural second network members are configured as sensing devices configured to sense one or more parameters of a patient, wherein the first network member is configured to receive information corresponding to the one or more parameters of the patient via the second channel from the plural second network members, and to provide a display corresponding to the information received from the plural second network members.

8. The system of claim 1, wherein the first channel is configured for transmitting between the first network member and the second network member a corresponding unique identification number for each of the first network member and the second network member, the unique identification numbers configured for at least one of authentication or encryption of messages over the second channel.

9. A tangible and non-transitory computer readable medium comprising one or more computer software modules configured to direct one or more processors to:
identify, at a module of a network coordinator, a node for one of pairing or un-pairing to the network coordinator;
communicate network pairing information with the node via a first channel, the network pairing information configured to at least one of pair or un-pair the network coordinator and the node, the first channel configured to wirelessly transmit power from the network coordinator to the node, the network pairing information transmitted via the first channel at a first frequency; and,
communicate operational information with the node via a second channel when the network coordinator and the node are paired, the operational information transmitted via the second channel at a second frequency that is different than the first frequency.

10. The computer readable medium of claim 9, wherein the computer readable medium is further configured to direct the one or more processors to identify the node for one of pairing or un-pairing to the network coordinator based on a detected proximity of the node to the network coordinator.

11. The computer readable medium of claim 10, wherein the computer readable medium is further configured to direct the one or more processors to un-pair the network coordinator and the node when the network coordinator and the node are brought within a predetermined distance when the network coordinator and the node are paired, and to pair the network coordinator and the node when the network coordinator and the node are brought within the predetermined distance when the network coordinator and the node are not paired.

12. The computer readable medium of claim 9, wherein the network coordinator is configured as a monitor for a medical monitoring system, wherein the node is configured as a sensing device configured to sense one or more parameters of a patient, wherein the network coordinator is configured to receive information corresponding to the one or more parameters of the patient via the second channel from the node, and to provide a display corresponding to the information received from the node.

13. The computer readable medium of claim 9, wherein the first channel is configured for transmitting between the node and the network coordinator a corresponding unique identification number for each of the node and the network coordinator, the unique identification numbers configured for at least one of authentication or encryption of messages over the second channel.

14. A tangible and non-transitory computer readable medium comprising one or more computer software modules configured to direct one or more processors to:
identify, at a module of a node, a network coordinator for one of pairing or un-pairing to the node;
communicate network pairing information with the network coordinator via a first channel, the network pairing information configured to at least one of pair or un-pair the node and the network coordinator, the first channel configured to wirelessly receive power from the network coordinator, the network pairing information transmitted via the first channel at a first frequency; and,
communicate operational information with the network coordinator via a second channel when the node and the network coordinator are paired, the operational information transmitted via the second channel at a second frequency that is different than the first frequency.

15. The computer readable medium of claim 14, wherein the computer readable medium is further configured to direct the one or more processors to identify the network coordinator for one of pairing or un-pairing to the node based on a detected proximity of the node to the network coordinator.

16. The computer readable medium of claim 15, wherein the computer readable medium is further configured to direct the one or more processors to direct the one or more processors to un-pair the network coordinator and the node when the network coordinator and the node are brought within a predetermined distance when the network coordinator and the node are paired, and to pair the network coordinator and the node when the network coordinator and the node are brought within the predetermined distance when the network coordinator and the node are not paired.

17. The computer readable medium of claim 14, wherein the node is configured as a sensing device configured to sense one or more parameters of a patient, wherein the network coordinator is configured as a monitor for a medical monitoring system, wherein the node is configured to transmit information corresponding to the one or more parameters of the patient via the second channel to the network coordinator.

18. The computer readable medium of claim 14, wherein the first channel is configured for transmitting between the node and the network coordinator a corresponding unique identification number for each of the node and the network coordinator, the unique identification numbers configured for at least one of authentication or encryption of messages over the second channel.

19. The computer readable medium of claim 14, wherein the computer readable medium is further configured to direct the one or more processors to determine if the node has been brought within a predetermined distance of a charger configured to provide energy to the node via the first channel, and to enter a charging mode if the node has been brought within the predetermined distance of the charger.

20. The computer readable medium of claim 14, wherein the computer readable medium is further configured to direct the one or more processors to prevent pairing of the node to the network coordinator if the node is currently paired with a different network coordinator.
